(19) United States
(12) Patent Application Publication
(10) Pub. No.: US 2013/0161365 A1
(43) Pub. Date: Jun. 27, 2013

(54) ADJUSTABLE STRUCTURE OF BICYCLE WATER BOTTLE RACK

(71) Applicant: Ho-Jen Shih, Changhua (TW)

(72) Inventor: Ho-Jen Shih, Changhua (TW)

(73) Assignee: NUVO ENTERPRISE CO., LTD., CHANGHUA (TW)

(21) Appl. No.: 13/335,842

(22) Filed: Dec. 22, 2011

(51) Int. Cl. B62J 11/00

(52) U.S. Cl. 224/414

(57) ABSTRACT

An adjustable structure of a bicycle water bottle rack includes a water bottle rack, an adjustable device and a string. The adjustable device is located at a front end of a first and a second clamping arms of the water bottle rack. One end of the string is fixed at a string collecting slot of an adjusting unit, and the string penetrates out from the string collecting slot and the connecting hole of the base, and is inserted into the through hole and a string slot of the first clamping arm, and disposed at the a string slot of the water bottle rack. Furthermore, the string passes through the second clamping arm and is fixed at the base. A receiving space between the first and second clamping arms can be adjusted, so that the water bottle rack can be used for water bottles with different sizes.

### FIELD OF THE INVENTION

The present invention relates to an adjustable structure of a bicycle water bottle rack, and particularly to a structure that the user can rotate a cap to drive an adjusting unit and a string to increase/decrease a receiving space between a first clamping arm and a second clamping arm, so the water bottle rack can be used for a water bottle with different sizes to increase the practicability thereof.

### BACKGROUND OF THE INVENTION

A conventional bicycle is usually equipped with a water bottle rack, so that a user can supplement water while riding the bicycle. The structure of the water bottle rack usually has a supporting base fixed to the body of the bicycle, and two clamping arms extend from the supporting base to form a receiving space to dispose the water bottle. However, since the clamping arms have limited degree of elastic deformation, the water bottle rack cannot be used for water bottles with different sizes and the practicability of the water bottle rack decreases. Also, the clamping arms can easily become elastic fatigue by holding the water bottle and the clamping force can be reduced significantly. The water bottle rack can therefore fail to effectively hold the water bottle and lose the durability thereof.

### SUMMARY OF THE INVENTION

The problem to be solved in the present invention is (a) the clamping arms have limited degree of elastic deformation, the water bottle rack cannot be used for water bottles with different sizes and the practicability of the water bottle rack decreases; and (b) the clamping arms can easily become elastic fatigue by holding the water bottle and the clamping force can be reduced significantly. The water bottle rack can therefore fail to effectively hold the water bottle and lose the durability thereof.

The technical point to solve the problem is to provide an adjustable structure of a bicycle water bottle rack includes a water bottle rack, an adjustable device and a string. The water bottle rack has a connecting portion at a rear end thereof and connecting to the bicycle. A first clamping arm and a second clamping arm extend forward from both sides of the connecting portion, and a receiving space is formed between the first clamping arm and second clamping arm. A string slot is formed at an outer periphery of the first clamping arm and second clamping arm. The adjustable device has a base that attaches to a front end of the first clamping arm and second clamping arm, and a pair of through holes are formed on both sides of the base. A second receiving space with a front opening is recessedly formed between two through holes, and the second receiving space has a plurality of engaging teeth formed at an opening thereof. A stopping edge is formed at an inner portion of the opening, and the stopping edge has a connecting hole on each side thereof. A pole is protrudingly formed at center of an opening surface of the second receiving space, and the pole has an adjusting unit having a through hinge hole that is provided for the base and the pole to engage with each other. A string collecting slot is recessedly formed at a periphery of the adjusting unit, and the string collecting slot has a stopping plate and a rotating plate on both sides. The stopping plate is secured at the stopping edge of the base, and the rotating plate has a plurality of resilient ribs at an outer periphery of the rotating plate that engage with the engaging teeth of the base. Moreover, a cap is disposed on a surface of the rotating plate. The string penetrates out from the string collecting slot and the connecting hole of the base, and is inserted into the through hole and the string slot of the first clamping arm and the water bottle rack. The string is then fixed to the base through the string slot of the second clamping arm to obtain an adjustable structure of a bicycle water bottle rack.

### BRIEF DESCRIPTION OF THE DRAWINGS

FIG. 1 illustrates a three-dimensional assembled view in the present invention.

FIG. 2 illustrates a three-dimensional exploded view in the present invention.

FIG. 3 illustrates a front schematic view in the present invention.

FIG. 4 illustrates a sectional view (look down) in the present invention.

FIG. 5 illustrates a sectional view (look down) and partially enlarging view in the present invention.

FIG. 6 illustrates a schematic view of the present invention in use.

FIG. 7 illustrates a sectional view (in action) and partially enlarging view in the present invention.

FIG. 8 illustrates a second schematic view of the present invention in use.

FIG. 9. illustrates a second sectional view (in action) and partially enlarging view in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

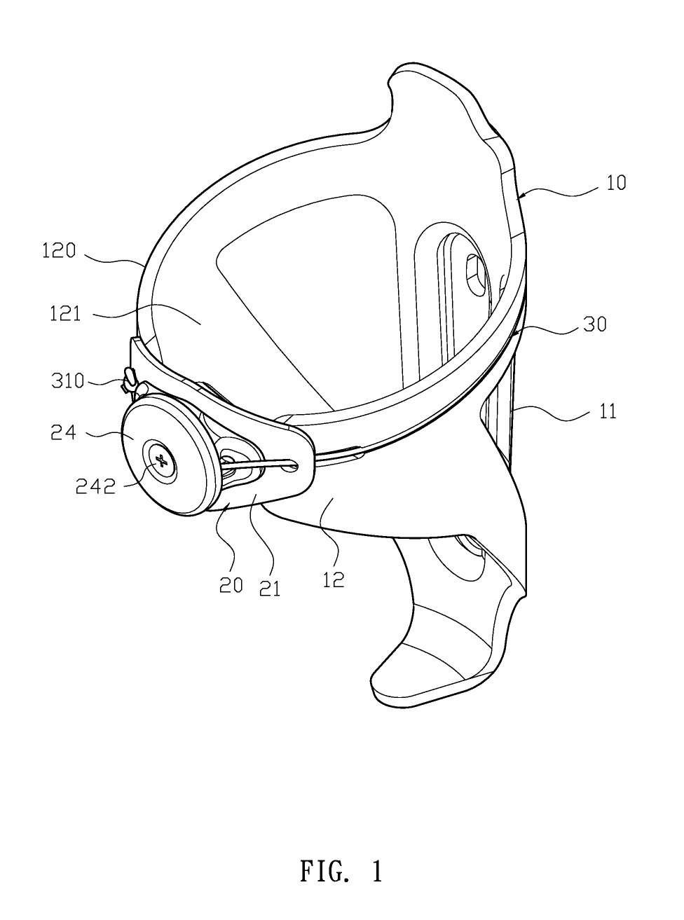

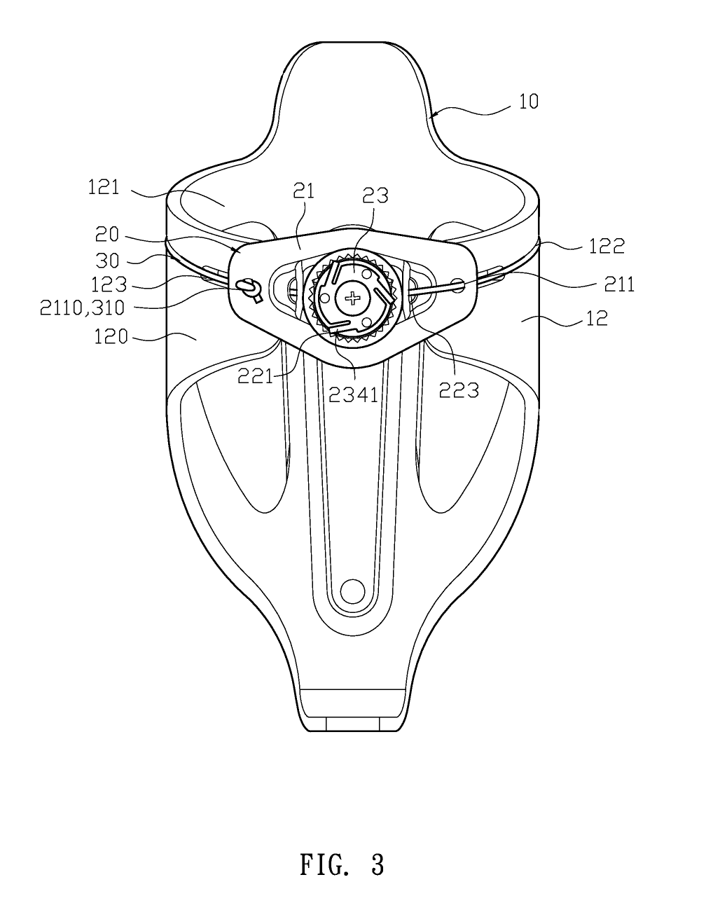

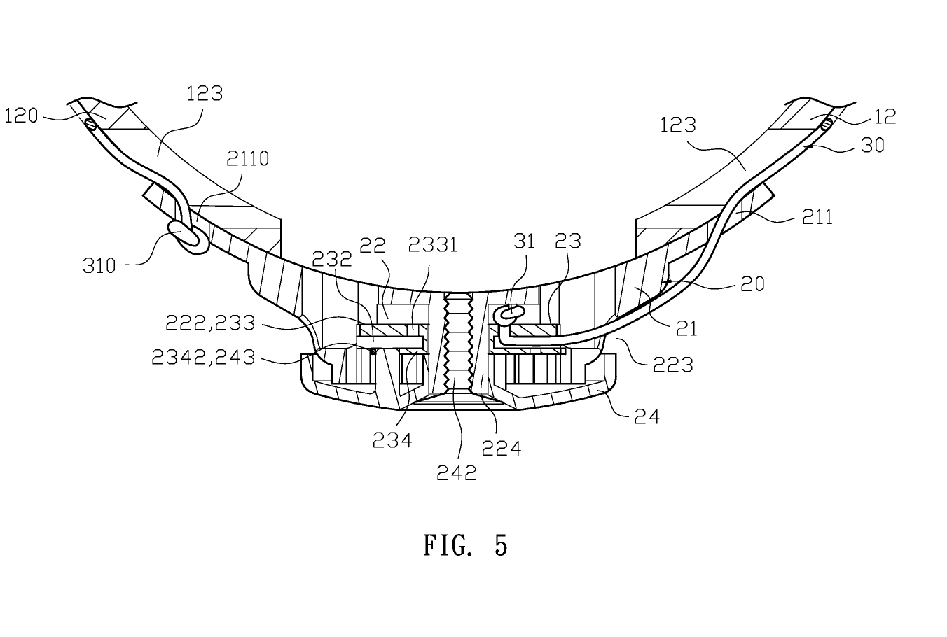

Referring to FIGS. 1 to 3, an adjustable structure of a bicycle water bottle rack includes a water bottle rack (10), an adjustable device (20) and a string (30). The water bottle rack (10) has a connecting portion (11) at a rear end thereof and connecting to the bicycle. A first clamping arm (11) and a second clamping arm (12) extend forward from both sides of the connecting portion (11), and a receiving space (121) is formed between the first clamping arm (11) and second clamping arm (12). A string slot (122) is formed at an outer periphery of the first clamping arm (11) and second clamping arm (12), and an expanded hole (123) is located near a front end of the string slot (122). The adjustable device (20) has a base (21) that attaches to a front end of the first clamping arm (11) and second clamping arm (12), and a pair of through holes (211) (2110) are formed on both sides of the base (21), corresponding to the expanded hole (123) of the water bottle rack (10). A second receiving space (22) with a front opening is recessedly formed between two through holes (211) (2110), and the second receiving space (22) has a plurality of engaging teeth (221) formed at an opening thereof. A stopping edge (222) is formed at an inner portion of the opening, and the stopping edge (222) has a connecting hole (223) on each side thereof. A pole (224) is protrudingly formed at center of an opening surface of the second receiving space (22), and the pole (224) has a recessed engaging hole (2241) and an adjusting unit (23) having a through hinge hole (231) that is provided for the base (21) and the pole (224) to engage with each other. A string collecting slot (232) is recessedly formed at a periphery of the adjusting unit (23), and the string collecting slot (232) has a stopping plate (233) and a rotating plate (234) on both sides. The stopping plate (233) is secured at the stopping edge (222) of the base (21), and a second through hole (2331) used to connect the string collecting slot (232) is formed outside the stopping plate (233). The rotating plate (234) has a plurality of resilient ribs (2341) at an outer periphery of the rotating plate (234) that engage with the engaging teeth of the base (21), and a plurality of plugging holes (2342) are recessedly formed at a surface of the rotating plate (234). A cap (24) having a through opening (241) is disposed and the through opening (241) is provided for the pole (224) of the base (21) to pass through, and the through opening (241) provides a connecting unit (242) that is connected to the engaging hole (2241) of the pole (224) to form a stopping status. A plurality of wedging poles (243) are formed on the surface of the cap (24) to engage with the plugging holes (2342) of the rotating plate (234). One end of the string (30) passes through the outer portion of the second through hole (2331) of the adjusting unit (23) and the string collecting slot (232), and the other end ties to form a fixed end (31) to block the second through hole (2331) to form a stopping status (see FIG. 5 as well). The string (30) then penetrates out from the string collecting slot (232) and the connecting hole (223) of the base (21), and is inserted into the through hole (211) and the expanded hole (123) of the first clamping arm (12). The string (30) is then disposed on the string slot (122) of the water bottle rack (10), and passes through the expanded hole (123) of the second clamping arm (120) and the through hole (2110) of the base (21), and ties to form a second fixed end (310) to block the through hole (2110) to form a stopping status. The hinge hole (231) of the adjusting unit (23) is wedged at the pole (224) of the base (21), and the stopping plate (233) is against the stopping edge (222), so that the resilient ribs (2341) of the rotating plate (234) engage with the engaging teeth (221) of the base. The wedging poles (243) of the cap (24) plug in the plugging holes (2342) of the rotating plate (234), so that a user can rotate the adjusting unit (23) through rotating the cap (24). The connecting unit (242) then passes through the through opening (241), and is connected with the engaging hole (2241) of the pole (224) of the base to form a stopping status to complete the assembly process.

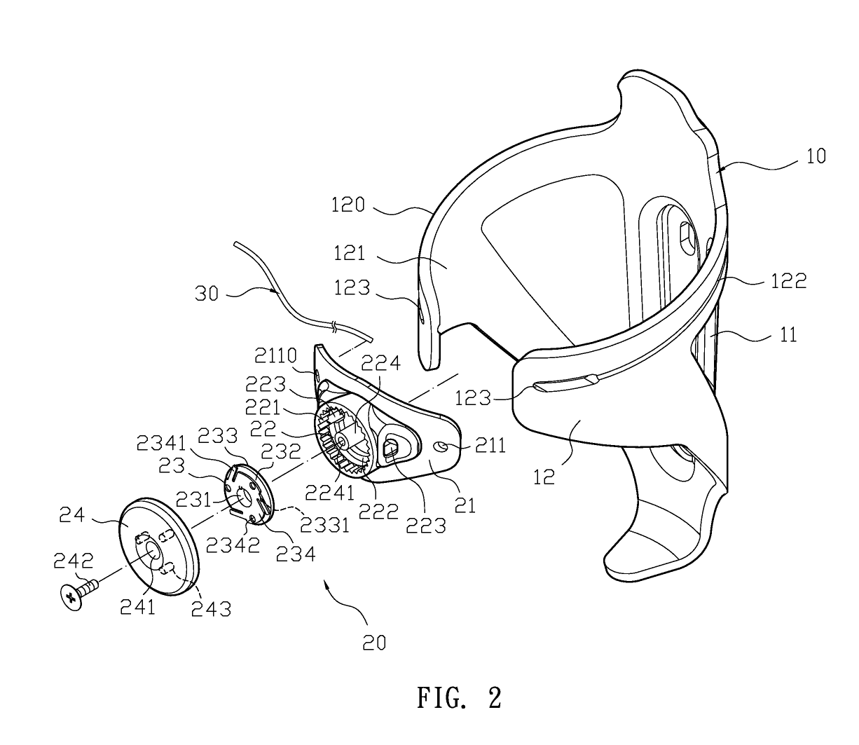

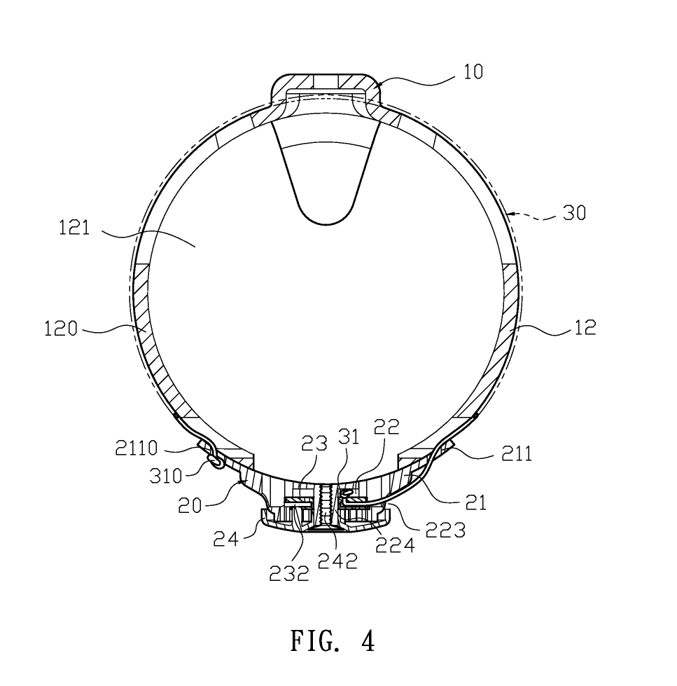

Referring to FIGS. 2 to 5 for the structure of the present invention, one end of the string (30) passes through the outer portion of the second through hole (2331) of the adjusting unit (23) and the string collecting slot (232), and the other end ties to form a fixed end (31) to block the second through hole (2331) to form a stopping status. The string (30) then penetrates out from the string collecting slot (232) and the connecting hole (223) of the base (21), and is inserted into the through hole (211) and the expanded hole (123) of the first clamping arm (12). The string (30) is then disposed on the string slot (122) of the water bottle rack (10), and passes through the expanded hole (123) of the second clamping arm (120) and the through hole (2110) of the base (21), and ties to form a second fixed end (310) to block the through hole (2110) to form a stopping status. Furthermore, the hinge hole (231) of the adjusting unit (23) engages with the pole (224) of the base (21), and the stopping plate (233) is against the stopping edge (222) of the base (21), so that the resilient ribs (2341) of the rotating plate (234) engage with the engaging teeth of the base (21). The cap (24) is plugged into the plugging holes (2342) of the rotating plate (234) through the wedging poles (243), so that the user can rotate the adjusting unit (23) by rotating the cap (24). The connecting unit (242) passes through the through opening (241), and is connected with the engaging hole (2241) of the pole (224) of the base (21) to complete the assembly process.

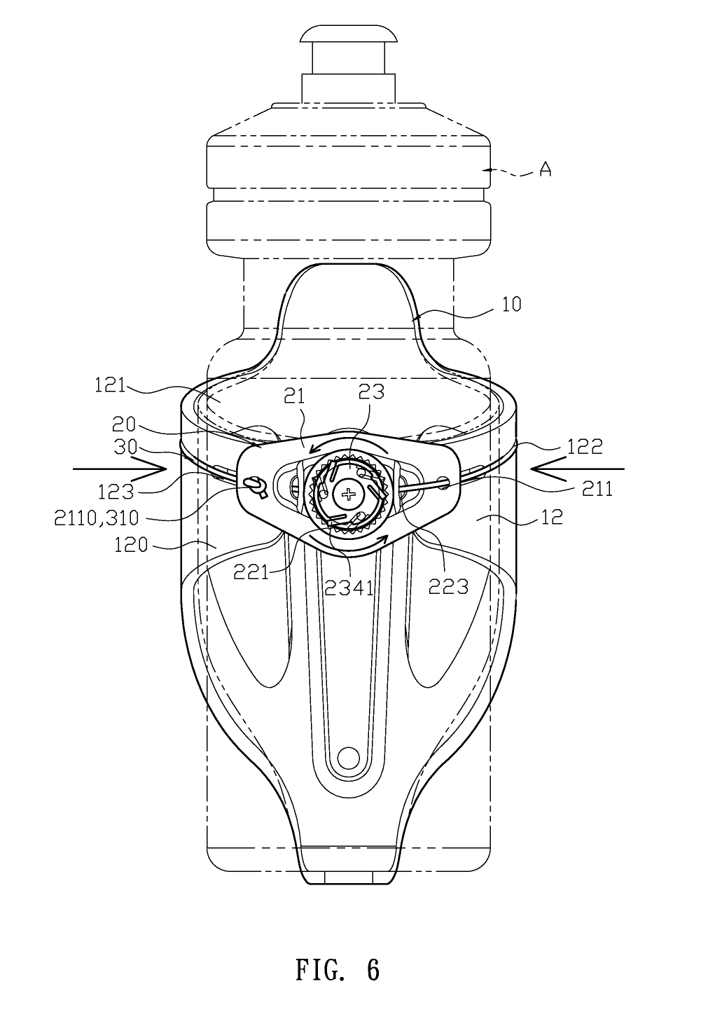

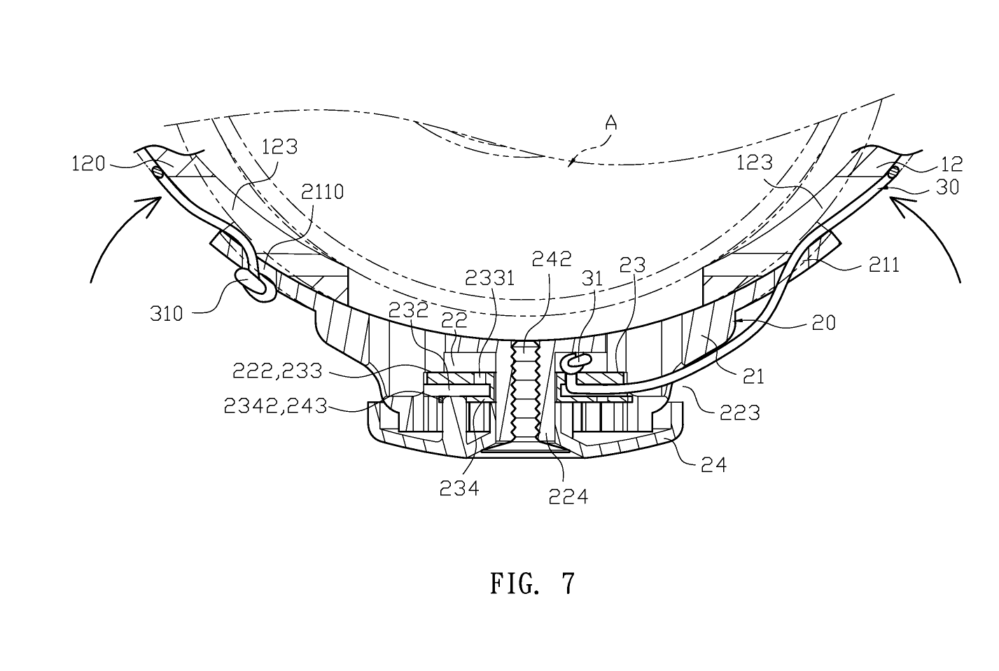

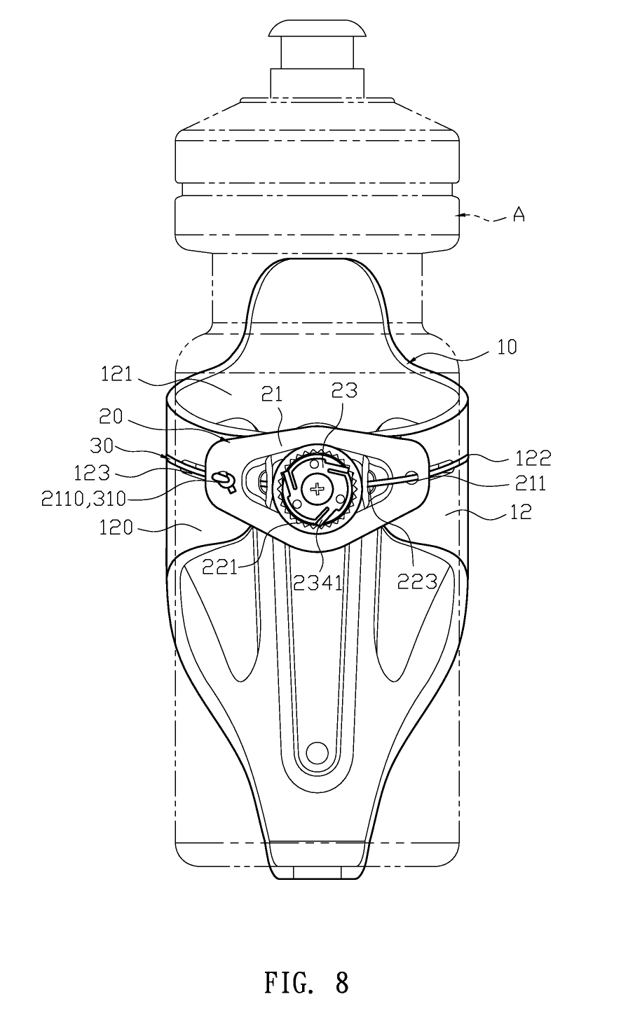

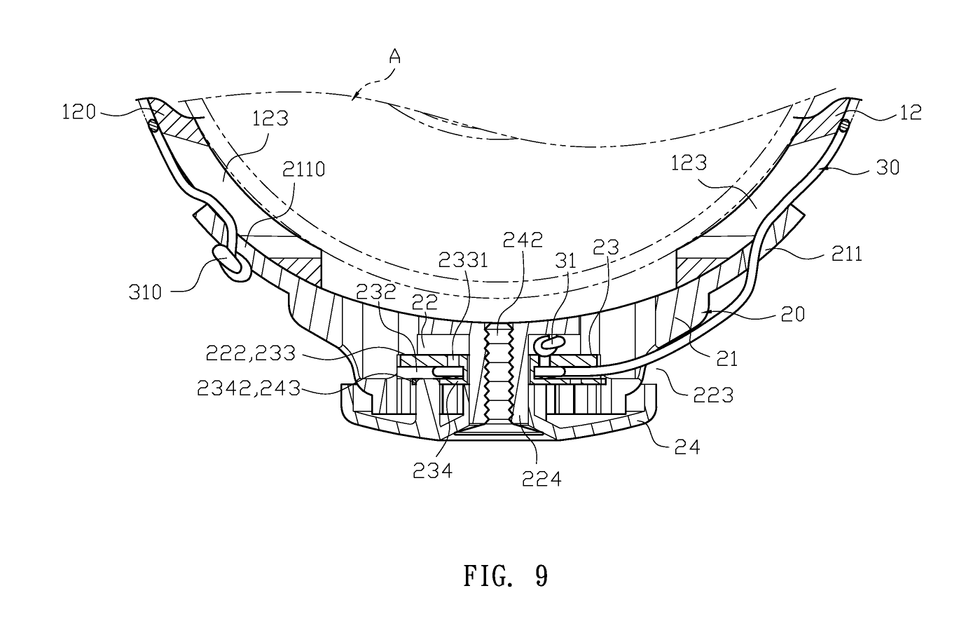

Referring to FIGS. 6 and 7 for actual usage, a water bottle (A) is disposed into the receiving space (121) of the water bottle rack (10) and the cap (24) is rotated. The cap (24) is plugged into the plugging holes (2342) of the rotating plate (234) through the wedging poles (243) to drive the adjusting unit (23) to rotate simultaneously, so that the resilient ribs (2341) of the adjusting unit (23) is compressed inwardly by the engaging teeth (221) of the base (21). Meanwhile, since the string (30) fixed to the adjusting unit (23) is disposed at the outer periphery of the first clamping arm (12) and the second clamping arm (120) of the water bottle rack (10), when the adjusting unit (23) is rotated, the string (30) can be gradually collected into the string collecting slot (232) of the adjusting unit (23). Also, the string (30) can gradually bring the first clamping arm (12) and the second clamping arm (120) of the water bottle rack (10) together, so that the first clamping arm (12) and the second clamping arm (120) can tightly clamp the periphery of the water bottle (A), and the resilient ribs (2341) of the adjusting unit (23) is expanded outwardly to engage with the engaging teeth (221) to form a secure positioning (see FIGS. 8 and 9 as well). Furthermore, since the string (30) is disposed outside the first clamping arm (12) and the second clamping arm (120) of the water bottle rack (10), the clamping force of the first clamping arm (12) and the second clamping arm (120) increases to effectively secure the water bottle (A), and to avoid elastic fatigue of the first clamping arm (12) and the second clamping arm (120) to increase the durability of the product. Moreover, the first clamping arm (12) and the second clamping arm (120) has the expanded hole (123) at the front end of the string slot (122), and the expanded hole (123) is corresponding the through holes (211) (2110) of the base (21), so the base (21) is not too close to the string slot (122) of the first clamping arm (12) and the second clamping arm (120) to interfere with string restoration. When the user wants to take out the water bottle (A), he/she can reversely rotate the cap (24) as well as the adjusting unit (23), and the restored string (30) in the string collecting slot (232) gradually rolls out to loosen the first clamping arm (12) and the second clamping arm (120), namely the receiving space (121) of the water bottle rack (10), so that the user can easily take the water bottle (A) out. Also, since the string (30) can be driven by the adjusting unit (23) to increase/decrease the receiving space (121) between the first clamping arm (12) and the second clamping arm (120), the water bottle rack (10) can be used for the water bottle (A) with different sizes to increase the practicability thereof.

According to the embodiment stated above, the present invention is advantageous because (a) the user can rotate the cap (24) to drive the adjusting unit (23) and the string (30) to increase/decrease the receiving space (121) between the first clamping arm (12) and the second clamping arm (120), so the water bottle rack (10) can be used for the water bottle (A) with different sizes to increase the practicability thereof; and (b) the string (30) is disposed outside the first clamping arm (12) and the second clamping arm (120) of the water bottle rack (10), the clamping force of the first clamping arm (12) and the second clamping arm (120) increases to effectively secure the water bottle (A), and to avoid elastic fatigue of the first clamping arm (12) and the second clamping arm (120) to increase the durability of the product.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. An adjustable structure of a bicycle water bottle rack comprising:
a water bottle rack having a connecting portion at a rear end thereof; a first clamping arm and a second clamping arm extend forward from both sides of the connecting portion, a receiving space between the first clamping arm and second clamping arm; and a string slot at an outer periphery of the first clamping arm and second clamping arm;
an adjustable device having a base that attaches to a front end of the first clamping arm and the second clamping arm, a pair of through holes formed on both sides of the base, and a second receiving space with a front opening recessedly formed between two through holes, wherein the second receiving space has a plurality of engaging teeth formed at an opening thereof, and a stopping edge is formed at an inner portion of the opening, and the stopping edge has a connecting hole on each side thereof, wherein a pole is protrudingly formed at center of an opening surface of the second receiving space, and the pole has an adjusting unit having a through hinge hole that is provided for the base and the pole to engage with each other, wherein a string collecting slot is recessedly formed at a periphery of the adjusting unit, and the string collecting slot has a stopping plate and a rotating plate on both sides, wherein the stopping plate is secured at the stopping edge of the base, and the rotating plate has a plurality of resilient ribs at an outer periphery of the rotating plate that engage with the engaging teeth of the base, and a cap is disposed on a surface of the rotating plate; and
a string, one end of which fixed at the string collecting slot of the adjustable device, and the string penetrating out from the connecting hole of the base from the string collecting slot, and inserting into the through hole and the string slot of the first clamping arm, wherein the string is disposed at the string slot of the water bottle rack and then fixed to the base through the string slot of the second clamping arm.

2. The adjustable structure of a bicycle water bottle rack of claim 1, wherein an expanded hole is located near a front end of the string slot, and through hole of the adjustable device is corresponding to the expanded hole.

3. The adjustable structure of a bicycle water bottle rack of claim 1, wherein an engaging hole is recessedly formed at the pole of the base and the cap has a through opening provided for the pole of the base to pass through, and the through opening provides a connecting unit that is connected to the engaging hole of the pole to form a stopping status.

4. The adjustable structure of a bicycle water bottle rack of claim 1, wherein a second through hole used to connect the string collecting slot is formed outside the stopping plate, and one end of the string passes through the string collecting slot from an outer portion of the second through hole, and the other end is tightened to form a fixed end to block the second through hole.

5. The adjustable structure of a bicycle water bottle rack of claim 1, wherein a plurality of plugging holes are recessedly formed on a surface of the rotating plate, and a plurality of wedging poles formed at a surface of the cap engage with the plugging holes of the rotating plate.

6. The adjustable structure of a bicycle water bottle rack of claim 1, wherein the string passes through the through holes of the second clamping arm, and is tightened to form a second fixed end to block the other through hole of the base.
